(19) United States
(12) Patent Application Publication
(10) Pub. No.: US 2016/0276782 A1
(43) Pub. Date: Sep. 22, 2016

(54) GROUNDING STRUCTURE OF CONNECTOR

(71) Applicant: SPEED TECH CORP., TAOYUAN CITY (TW)

(72) Inventors: Hua-Chun CHANG, TAOYUAN CITY (TW); Hsien-Chang LIN, TAOYUAN CITY (TW)

(21) Appl. No.: 15/071,216

(22) Filed: Mar. 16, 2016

(30) Foreign Application Priority Data
Mar. 18, 2015 (TW) 104204114

(51) Int. Cl. H01R 13/6585; H01R 13/627

(52) U.S. Cl. CPC H01R 13/6585; H01R 13/627

(57) ABSTRACT

A grounding structure of a thin-typed connector includes an insulating main body, a first terminal group, a second terminal group, a shielding case and a grounding sheet. The insulating main body is disposed with a base portion and a tongue plate. The grounding sheet is fixed between the base portion and the tongue plate. The first and the second terminal groups are accommodated in the insulating main body which is accommodated in the shielding case. The grounding sheet is formed to a shielding plate and a first flat plate from a metal sheet. The shielding plate is located on the tongue plate. The first flat plate is located on the base portion. Two sides of the main body of the grounding sheet bend and extend outwards, and are respectively disposed with a snapping portion. The snapping portions are configured to mutually snap and fix with a docking connector.

### RELATED APPLICATIONS

This application claims priority to Taiwanese Application Number 104204114, filed Mar. 18, 2015, which is herein incorporated by reference.

### BACKGROUND

1. Technical Field

The present disclosure relates to grounding structures of connectors. More particularly, the present disclosure relates to grounding structures of thin type connectors, of which a snapping device can reduce the structural damage of the connector body produced when the thin type connectors are mutually assembled with a docking connector.

2. Description of Related Art

Under the trend of the minimization of the size of the electronic devices, the overall volume of connectors must also be minimized, such that the internal components of the connectors should also be developed to thin structures. In order to match and communicate with a docking device, a connector requires a docking device to be mutually assembled with. When the product test of mass production is carried out, the accumulated frequency of matching and docking increases. Since the surface area of the thin structures is small, it cannot effectively resist the colliding pressure produced when the docking connectors are mutually contacted. Thus, severe damage on the surface structure of the connector body may easily result, leading to customer complaints after shipment. In addition, when docking assembly is carried out, structural stability gradually declines and consequently effective docking cannot be carried out.

Please refer to FIG. 15. FIG. 15 is an exploded view of the prior art previously disclosed in Taiwan patent M484832. As shown in FIG. 15, the Taiwan patent M484832 discloses a universal serial bus connector. The universal serial bus connector includes an insulating case A1, a first group terminal A2, a second group terminal A3, a shielding case A4 and a plurality of grounding connectors A13. The first group terminal A2 and the second group terminal A3 are accommodated in the insulating case A1. The insulating case A1 is accommodated and installed in the shielding case A4. Each of the grounding connectors A13 is fixed on the insulating case A1.

In the disclosure of the prior art, the insulating case A1 is disposed with a body portion A11. The body portion A11 extends outwards to form a tongue portion A12. Each of the grounding connectors A13 is fixed between the body portion A11 and the tongue portion A12. The body portion A11 forms a hollow case A14. The insulating case A1 additionally disposes an isolation plate A16 at the center of the hollow case A14 of the body portion A11. The isolation plate A16 is partially fixed between the body portion A11 and the tongue portion A12. The first group terminal A2 and the second group terminal A3 are shielded and isolated from the insulating case A1 by the isolation plate A16. This means the isolation plate A16 is enhanced to shield and isolate the electromagnetic radiation between the first group terminal A2 and the second group terminal A3. Moreover, the shielding case A4 is cut and bent to form to a frame structure from a metal sheet by stamping. The insulating case A1 is accommodated and installed in the shielding case A4. The surface A42 of the shielding case A4 is disposed with at least one bump A41. The bump A41 recesses inwards from the surface A42, such that the bump A41 is electrically connected with the grounding connectors A13.

In the disclosure of the prior art, since the isolation plate A16 is formed from a flat and thin sheet, this design leads to a relative limitation of the area of the two sides due to the limitation of the thin structure. When a durability test of assembly is carried with a docking device, severe wearing of the surface area as contacted with the docking device may easily result. Thus, the overall yield rate of the products cannot be increased, leading to problems to be solved in production.

### SUMMARY

A technical aspect of the present disclosure provides a grounding structure of a connector, of which two sides are respectively disposed with at least a snapping portion, so as to avoid the damage of the surface structure of the connector during assembly.

According to an embodiment of the present disclosure, a grounding structure of a connector includes a shielding case, an insulating main body, a first terminal group, a second terminal group and a grounding sheet. The insulating main body is accommodated in the shielding case. The first and the second terminal groups are accommodated in the insulating main body. The grounding sheet is a thin plate structure. The grounding sheet has a main body and at least two snapping portions. Two sides of the main body bend and extend outwards. The snapping portions are respectively disposed at each of the two sides of the main body. The snapping portions are configured to mutually snap and fix with a docking connector. Through the reinforcement of the snapping contact area of the grounding sheet by the snapping portions, the severe wearing of the surface structure of the grounding sheet is alleviated during the durability test of assembly.

In one or more embodiments of the present disclosure, the insulating main body is disposed with a base portion and a tongue plate. The grounding sheet is in the insulating main body by insert molding. The grounding sheet is formed to a shielding plate and at least one first flat plate from a metal sheet through cutting and bending. The shielding plate is at least partially located on the tongue plate of the insulating main body. The first flat plate is at least partially located on the base portion of the insulating main body. Two sides of the shielding plate partially bend and extend outwards to respectively form the snapping portions. The shielding plate and the first flat plate are located on different planes of the insulating main body.

In one or more embodiments of the present disclosure, the grounding structure of the connector further includes a shielding cover. The shielding cover covers the shielding case. The shielding cover is enhanced to shield and isolate the electromagnetic radiation produced during the electrical connection of the connector. Moreover, the grounding sheet includes a contact piece. The contact piece is disposed at an outward extension of the first flat plate. The contact piece is at least partially exposed outside the base portion. The contact piece is partially and electrically connected with the shielding cover, in order to enhance to isolate the electromagnetic radiation, and to reduce the noise interference in the transmission of electronic signals.

In one or more embodiments of the present disclosure, the first flat plate partially bends downwards and extends, and then bends inwards to form the snapping portion at an end after extending parallel with the shielding plate for an appropriate distance. Each of the snapping portions bends inwards and barbs to form a hook. The hook matches with the snapping portions, effectively increasing the elastic curvature of the two sides of the grounding sheet. Moreover, the shielding plate can be configured to isolate the first terminal group and the second terminal group. The first terminal group includes a first fixing portion and a plurality of first terminals. The first terminals are assembled on the first fixing portion. The second terminal group includes a second fixing portion and a plurality of second terminals. The second terminals are assembled on the second fixing portion. Since the shielding plate distinguishes and isolates the signal transmission of the first terminals and the second terminals, the signals of the first terminals and the second terminals do not interfere with each other.

The other applications of the present disclosure become obvious by the disclosure of this specification. However, the disclosure of this specification is by the mutual snapping between the snapping portions of a grounding sheet of an insulating main body and a docking device to reduce the damage by collision during assembly. Moreover, the snapping portions of the connector and the grounding sheet are integrally molded, thus the production procedure is effectively simplified and the manufacturing cost is reduced. It will be apparent to the person having ordinary skill in the art that various modifications and variations can be made to the structure of the present disclosure without departing from the scope or spirit of the present disclosure.

### BRIEF DESCRIPTION OF THE DRAWINGS

The disclosure can be more fully understood by reading the following detailed description of the embodiments, with reference made to the accompanying drawings as follows:

FIG. 1 is a perspective view of a grounding structure of a connector according to the first embodiment of the present disclosure;

FIG. 2 is a partial perspective view of the grounding structure of FIG. 1;

FIG. 3 is an exploded view of the grounding structure of FIG. 1;

FIG. 4 is a perspective view of the grounding sheet of the grounding structure of FIG. 1 in the first view angle;

FIG. 5 is a perspective view of the grounding sheet of the grounding structure of FIG. 1 in the second view angle;

FIG. 6 is an exploded view of a grounding structure of a connector according to the second embodiment of the present disclosure;

FIG. 7 is a perspective view of the grounding sheet of the grounding structure of FIG. 6 in the first view angle;

FIG. 8 is a perspective view of the grounding sheet of the grounding structure of FIG. 6 in the second view angle;

FIG. 9 is a perspective view of a grounding sheet of a grounding structure of a connector according to the third embodiment of the present disclosure in the first view angle;

FIG. 10 is a perspective view of the grounding sheet of FIG. 9 in the second view angle;

FIG. 11 is a perspective view of a grounding sheet of a grounding structure of a connector according to the fourth embodiment of the present disclosure in the first view angle;

FIG. 12 is a perspective view of the grounding sheet of FIG. 11 in the second view angle;

FIG. 13 is a perspective view of a grounding sheet of a grounding structure of a connector according to the fifth embodiment of the present disclosure in the first view angle;

FIG. 14 is a perspective view of the grounding sheet of FIG. 13 in the second view angle; and

FIG. 15 is an exploded view of the prior art previously disclosed in Taiwan patent M484832.

### DETAILED DESCRIPTION

Drawings will be used below to disclose a plurality of embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

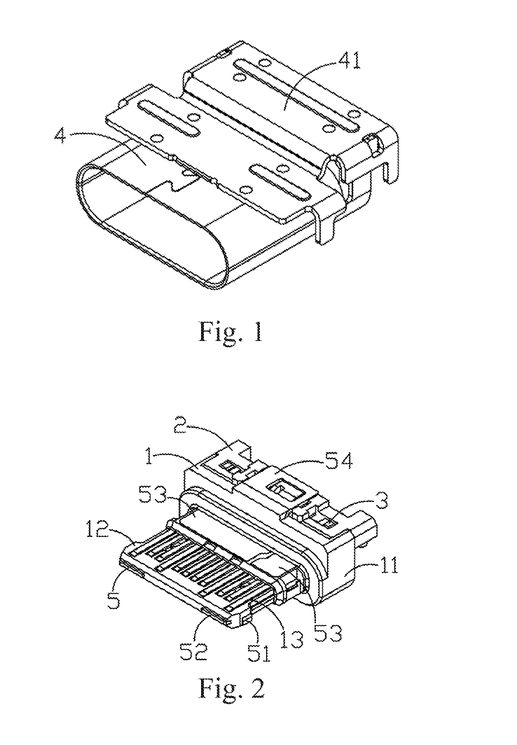

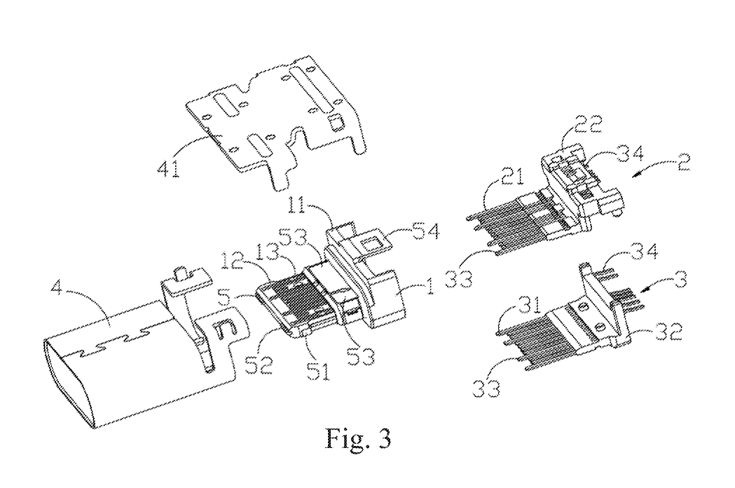

Please refer to FIGS. 1-3. FIG. 1 is a perspective view of a grounding structure of a connector according to the first embodiment of the present disclosure. FIG. 2 is a partial perspective view of the grounding structure of FIG. 1. FIG. 3 is an exploded view of the grounding structure of FIG. 1. As shown in FIGS. 1-3, the present disclosure provides a grounding structure of a connector. The grounding structure includes a shielding case 4, an insulating main body 1, a first terminal group 2, a second terminal group 3 and a grounding sheet 5. The insulating main body 1 is accommodated in the shielding case 4. The first terminal group 2 and the second terminal group 3 are accommodated in the insulating main body 1. The shielding case 4 is formed from a metal sheet through cutting and bending. The shielding case 4 covers outside the insulating main body 1, so as to block the electromagnetic waves inside and outside the insulating main body 1, and to avoid the production of noise under the effect of the electromagnetic waves outside during the transmission of high frequency electric signals by the first terminal group 2 and the second terminal group 3 in the insulating main body 1.

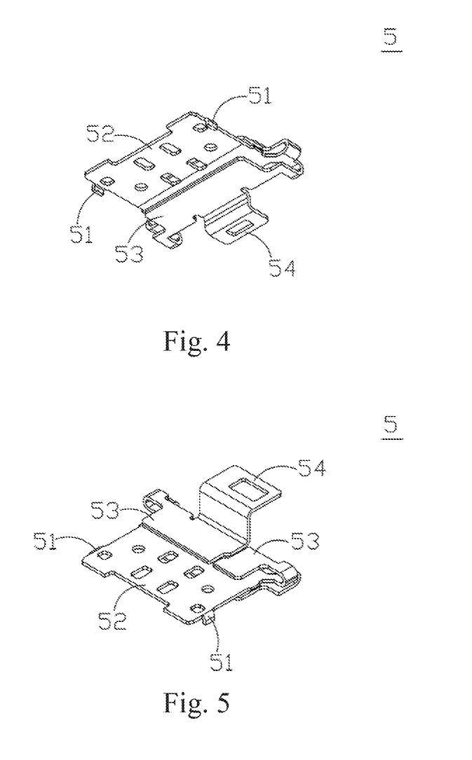

Please also refer to FIG. 4. FIG. 4 is a perspective view of the grounding sheet 5 of the grounding structure of FIG. 1 in the first view angle. As shown in FIGS. 3-4, in the first embodiment of the present disclosure, the grounding sheet 5 is a thin plate structure. The grounding sheet 5 has a main body and at least two snapping portions 51. Two sides of the main body bend and extend outwards. The snapping portions 51 are respectively disposed at each of the two sides of the main body. The snapping portions 51 are configured to mutually snap and fix with a docking connector (not shown). Through the reinforcement of the snapping contact area of the grounding sheet 5 by the snapping portions 51, the severe wearing of the surface structure of the grounding sheet 5 is alleviated during the durability test of assembly. The insulating main body 1 is disposed with a base portion 11. The base portion 11 extends and forms a tongue plate 12. Two non-adjacent surfaces on the tongue plate 12 are respectively disposed with a plurality of accommodation slots 13. The accommodation slots 13 are configured to accommodate the first terminal group 2 and the second terminal group 3.

Please also refer to FIG. 5. FIG. 5 is a perspective view of the grounding sheet 5 of the grounding structure of FIG. 1 in the second view angle. As shown in FIGS. 3-5, in the first embodiment of the present disclosure, the grounding sheet 5 is in the insulating main body 1 by insert molding. The grounding sheet 5 is formed to a shielding plate 52 and at least one first flat plate 53 from a metal sheet through cutting and bending. The shielding plate 52 is at least partially located on the tongue plate 12 of the insulating main body 1. The first flat plate 53 is at least partially located on a surface of the base portion 11 of the insulating main body 1. In order to reinforce the shielding effect of the grounding sheet 5, the front, back, left and right portions of the shielding plate 52 protrude from the tongue plate 12. When a docking connector (not shown) is under assembly, the relatively wider portions at the left and right sides of the shielding plate 52 contact the docking connector, in which two sides of the shielding plate 52 partially bend and extend outwards to respectively form the snapping portions 51. Through the increase of the colliding snapping contact area by the snapping portions, the surface pressure of the relatively wider portions at the sides of the shielding plate 52 is reduced. Moreover, the shielding plate 52 and the first flat plate 53 of the grounding sheet 5 are located on different planes of the insulating main body 1, so as to form the performance status of an upper and a lower levels.

As shown in FIGS. 3-5, in the first embodiment of the present disclosure, the grounding structure of the connector further includes a shielding cover 41. The shielding cover 41 covers the shielding case 4. The shielding cover 41 is enhanced to shield and isolate the electromagnetic radiation produced during the electrical connection of the connector. Moreover, the grounding sheet 5 includes a contact piece 54. The contact piece 54 is disposed at an outward extension of the first flat plate 53. The contact piece 54 is at least partially exposed outside the base portion 11 of the insulating main body 1. The contact piece 54 is partially and electrically connected with the shielding cover 41, in order to enhance to isolate the electromagnetic radiation, and to reduce the noise interference in the transmission of electronic signals.

As shown in FIGS. 3-5, in the first embodiment of the present disclosure, the shielding plate 52 can be configured to isolate the first terminal group 2 and the second terminal group 3. The first terminal group 2 includes a first fixing portion 22 and a plurality of first terminals 21. The first terminals 21 are assembled on the first fixing portion 22. The second terminal group 3 includes a second fixing portion 32 and a plurality of second terminals 31. The second terminals 31 are assembled on the second fixing portion 32. Each of the first terminals 21 and each of the second terminals 31 are disposed with a contact portion 33 and a holding portion 34. Each of the contact portions 33 is utilized to electrically connect with a docking device (not shown), and each of the holding portions 34 is utilized to electrically connect with an appropriate electronic circuit on an electric board (not shown). Since the shielding plate 52 distinguishes and isolates the signal transmission of each of the first terminals 21 and each of the second terminals 31, the signals of the first terminals 21 and the second terminals 31 do not interfere with each other.

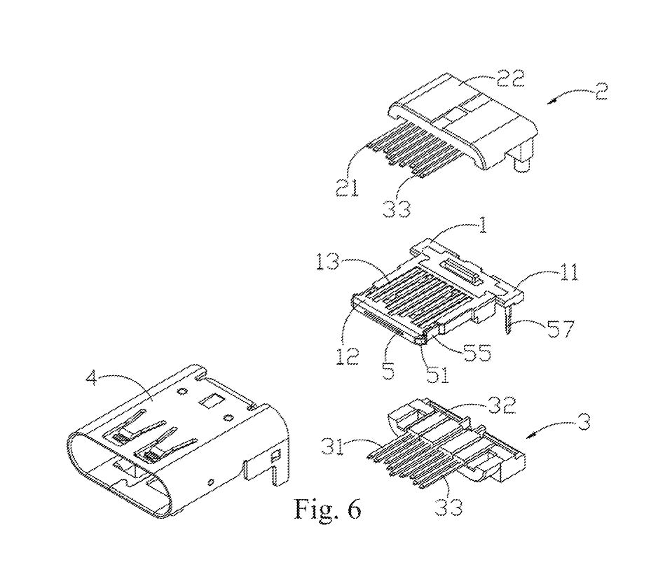

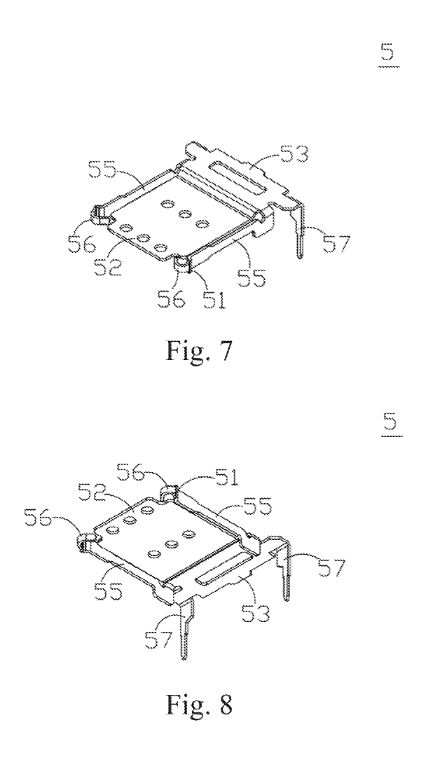

Please refer to FIGS. 6-8. FIG. 6 is an exploded view of a grounding structure of a connector according to the second embodiment of the present disclosure. FIG. 7 is a perspective view of the grounding sheet 5 of the grounding structure of FIG. 6 in the first view angle. FIG. 8 is a perspective view of the grounding sheet 5 of the grounding structure of FIG. 6 in the second view angle. As shown in FIGS. 6-8, in the second embodiment of the present disclosure, the two sides of the first flat plate 53 partially bend downwards and extend for a small distance, and then bend inwards to respectively form a long arm 55 after extending parallel with the shielding plate 52 for an appropriate distance. A snapping portion 51 is formed at an end of each of the long arms 55. Each of the snapping portions 51 bends inwards and barbs to form a hook 56. The hook 56 matches with the snapping portions 51, effectively increasing the elastic curvature of the long arms 55 at the two sides of the grounding sheet 5. Moreover, the first flat plate 53 of the grounding sheet 5 extends vertically downwards to form a tab 57. The tab 57 is utilized to electrically connect or interfere with a grounding terminal of an electric board (not shown), such that the grounding sheet 5 can transmit the noise of electromagnetic waves to the grounding circuit.

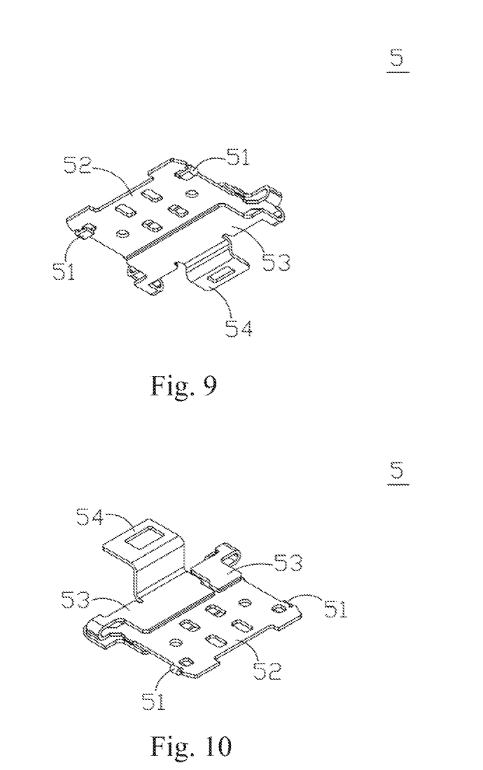

Please refer to FIGS. 9-10. FIG. 9 is a perspective view of a grounding sheet 5 of a grounding structure of a connector according to the third embodiment of the present disclosure in the first view angle. FIG. 10 is a perspective view of the grounding sheet 5 of FIG. 9 in the second view angle. As shown in FIGS. 9-10, in the third embodiment of the present disclosure, the widest portions at the two sides of the shielding plate 52 partially bend downwards from outside and extend for a small distance, and then the ends of the widest portions extend parallel with the shielding plate 52 for an appropriate distance. The portions protruded from the sides of the shielding plate 52 define the snapping portions 51. This design is a two-layer structure of overlapping plates, which can strength the stability strength of the snapping portions 51. Since the snapping portions 51 and the shielding plate 52 are integrally molded, the stability of assembly can be increased while the cost can be decreased.

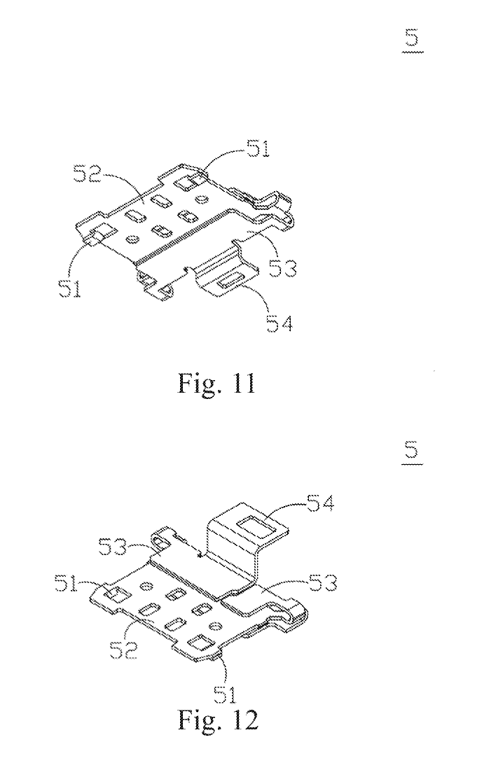

Please refer to FIGS. 11-12. FIG. 11 is a perspective view of a grounding sheet 5 of a grounding structure of a connector according to the fourth embodiment of the present disclosure in the first view angle. FIG. 12 is a perspective view of the grounding sheet 5 of FIG. 11 in the second view angle. As shown in FIGS. 11-12, in the fourth embodiment of the present disclosure, the widest portions at the two sides of the shielding plate 52 partially bend downwards from inside for a small distance, and then the ends of the widest portions extend parallel with the shielding plate 52 for an appropriate distance. The portions protruded from the sides of the shielding plate 52 define the snapping portions 51. This design is a two-layer structure of overlapping plates, which can strength the stability strength of the snapping portions 51. Since the snapping portions 51 and the shielding plate 52 are integrally molded, the stability of assembly can be increased while the cost can be decreased.

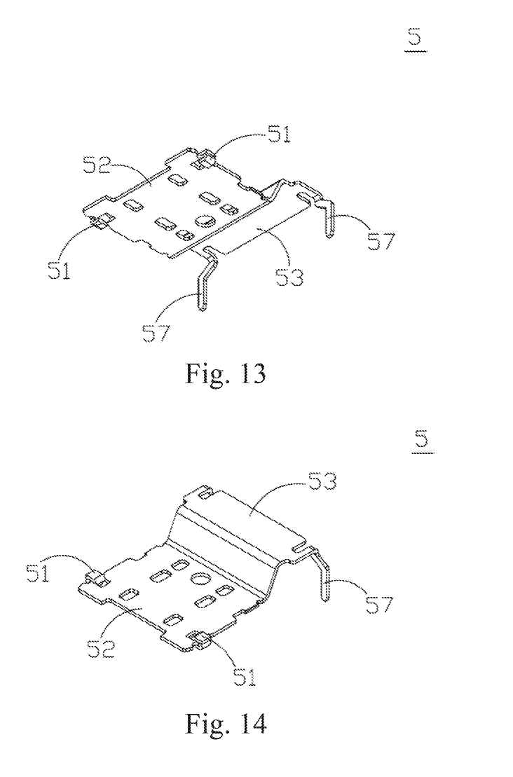

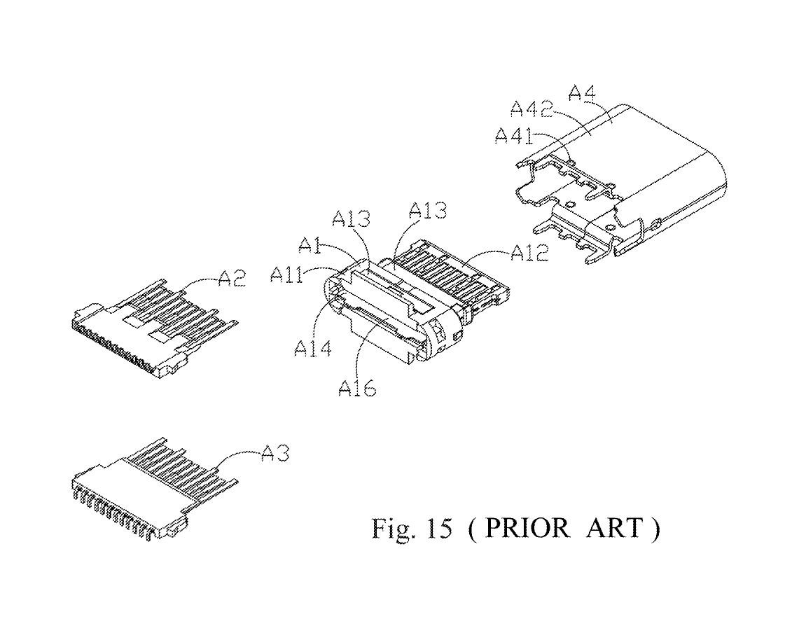

Please refer to FIGS. 13-14. FIG. 13 is a perspective view of a grounding sheet 5 of a grounding structure of a connector according to the fifth embodiment of the present disclosure in the first view angle. FIG. 14 is a perspective view of the grounding sheet 5 of FIG. 13 in the second view angle. As shown in FIGS. 13-14, in the fifth embodiment of the present disclosure, the widest portions at the two sides of the shielding plate 52 partially bend downwards from outside and extend for a small distance, and then the ends of the widest portions extend parallel with the shielding plate 52 for an appropriate distance, and then bend upwards from the inside and extend for a small distance, and then the ends of the widest portions extend parallel with the shielding plate 52 for an appropriate distance. The portions protruded from the sides of the shielding plate 52 define the snapping portions 51. This design is a three-layer structure of overlapping plates, which can strength the stability strength of the snapping portions 51. Since the snapping portions 51 and the shielding plate 52 are integrally molded, the stability of assembly can be increased while the cost can be decreased. Moreover, the first flat plate 53 of the grounding sheet 5 bends vertically downwards and extends to form a tab 57. The tab 57 is utilized to electrically connect or interfere with a grounding terminal of an electric board (not shown), such that the grounding sheet 5 can transmit the noise of electromagnetic waves to the grounding circuit.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A grounding structure of a connector, comprising:
a shielding case;
an insulating main body accommodated in the shielding case;
a first terminal group accommodated in the insulating main body;
a second terminal group accommodated in the insulating main body; and
a grounding sheet having a main body and at least two snapping portions, two sides of the main body bending and extending outwards, the snapping portions being respectively disposed at each of the two sides of the main body, wherein the snapping portions are configured to mutually snap and fix with a docking connector.

2. The grounding structure of the connector of claim 1, wherein the insulating main body is disposed with a base portion and a tongue plate, the grounding sheet is formed to a shielding plate and at least one first flat plate from a metal sheet through cutting and bending, the shielding plate is at least partially located on the tongue plate, the first flat plate is at least partially located on the base portion.

3. The grounding structure of the connector of claim 2, wherein two sides of the shielding plate partially bend and extend outwards to respectively form the snapping portions.

4. The grounding structure of the connector of claim 2, wherein the shielding plate and the first flat plate are located on different planes of the insulating main body.

5. The grounding structure of the connector of claim 2, wherein the grounding sheet comprises:
a contact piece disposed at an outward extension of the first flat plate, the contact piece is at least partially exposed outside the base portion.

6. The grounding structure of the connector of claim 2, wherein the first flat plate partially bends downwards and extends and then bends inwards to form the snapping portion at an end after extending parallel with the shielding plate for an appropriate distance.

7. The grounding structure of the connector of claim 6, wherein each of the snapping portions bends inwards and barbs to form a hook.

8. The grounding structure of the connector of claim 1, further comprising:
a shielding cover covering the shielding case.

9. The grounding structure of the connector of claim 1, wherein the first terminal group comprises:
a first fixing portion; and
a plurality of first terminals assembled on the first fixing portion.

10. The grounding structure of the connector of claim 1, wherein the second terminal group comprises:
a second fixing portion; and
a plurality of second terminals assembled on the second fixing portion.
